(19) United States
(12) Patent Application Publication
(10) Pub. No.: US 2025/0246170 A1
(43) Pub. Date: Jul. 31, 2025

(54) Torquing Tool With Pull Cord

(71) Applicant: D’Addario & Company, Inc., Farmingdale, NY (US)

(72) Inventors: Justin Tranchina, Old Bridge, NJ (US); Andrzej J. Krol, Wayne, NJ (US); Zachary Stringham, Brooklyn, NY (US)

(21) Appl. No.: 19/039,970

(22) Filed: Jan. 29, 2025

Related U.S. Application Data
(60) Provisional application No. 63/626,161, filed on Jan. 29, 2024.

(51) Int. Cl. G10D 13/16; B25B 13/46; B25B 23/14; B25B 23/142

(52) U.S. Cl. CPC G10D 13/16; B25B 13/46; B25B 23/1427; B25B 23/141

(57) ABSTRACT

A tool for torquing a rotatable element has a first bit and an opposite second bit, and housing. The first and second bits are rotationally fixed relative to each other and rotatable relative to the housing. A third stationary bit is included that is fixed relative to the housing. The first and second are operationally connected with a one way bearing assembly having a wound cord with a portion exposed from the housing. A user can operate the first and second bits by pulling the cord, causing the bearing assembly and first and second bits to rotate in a common absolute direction. The first bit can be connected to an element to rotate the element in a first installation direction when the cord is extended, and the second bit can be connected to the element to rotate the element in an opposite second installation direction when the cord is extended.

### CROSS-REFERENCE TO RELATED APPLICATION

This application claims priority to U.S. Provisional Patent Application No. 63/626,161, filed Jan. 29, 2024, for Torquing Tool with Pull Cord, the entire content of which is incorporated by reference in its entirety.

### BACKGROUND

The disclosed embodiments relate to tools, and in particular to a torquing tool or wrench for driving, uninstalling and/or adjusting drivable element. The tool may be specifically configured for installing, uninstalling and adjusting tension rods in a drum.

“Drum tuning” is the process of adjusting the tension of a drum in order to adjust sound properties. For example, players may tune a drum to remove unwanted overtones and/or otherwise produce the sound and response that is preferred. Additionally, some drums, such as timpani and rototoms, are tuned to a specific pitch. Drums are typically tuned by tightening or loosening tension rods or ropes, which control the tension on the drumhead. Tension rods are elongated threaded fasteners retained by a threaded nut, with a head shaped for receipt by a torquing tool, referred to in the field as a drum key. Most commonly, tension rods have a cubic or rectangular prismic shape on their exposed upper ends, and a drum key has a socket in one end with a closely corresponding shape.

Standard drum keys have a T-shape with an elongated axially extending bit that carries the socket on a distal end and a laterally extending cross member at the opposite end for twisting about the axis of the bit to torque an engaged tension rod. Traditionally, application of high torquing force requires a standard drum key with a 6-inch cross member, making it a stationary tool (not portable) due to its bulky shape and size. On the other hand, any traditional stationary drum keys that may be smaller in size and more portable are not suitable for applying high torquing forces, since the cross member is necessarily shorter in length. Drum keys with one-way ratchet mechanisms (similar to a ratchet wrench) have been developed with an aim toward improving efficiency, however, each tension rod still must be manually turned.

Installing tension rods and tuning a drum with these types of tools can be a lengthy and cumbersome process due to the many rotations required to be performed by hand. Tuning bits for use with a power tools (drill, for example) have been developed for the purpose of accelerating the process of installing tension rods. However, these power tools are necessarily forceful and coarse installation devices that lack the capability to finely adjust a tension rod to “fine tune” the acoustics of a drum. Power driving tools can also provide too much torquing power so as to strip tension rod threading or otherwise damage the drum hardware.

Thus, it would be useful to have a drum key that provides improved installation speed and efficiency with high torquing forces, while maintaining the capability to fine tune a tension rod.

### SUMMARY

In one embodiment a tool for use in torquing a drivable element has a first bit, one way bearing assembly and cord. The first bit is configured to engage with the drivable element. The one way bearing assembly is operatively connected to the first bit with the cord wound about the one way bearing assembly. Forcibly unwinding the cord causes the bearing and first bit to rotate in a first direction.

In another embodiment, a tool for use in torquing a drivable element has a frame, a first bit and a second bit, each rotatable relative to the frame. The first bit has a first engagement profile configured to engage with a drivable element. The second bit extends opposite from the first bit and has an engagement profile configured to engage with a drivable element. The first bit and second bit are rotationally fixed relative to each other. The tool also includes a third bit that is rotationally fixed relative to the frame and has an engagement profile configured to engage with a drivable element. A one-way bearing assembly is operatively connected to the first bit and second bit with a cord wound about it with an end exposed from the frame. Forcibly unwinding the cord by human action causes the bearing, first bit and second bit to rotate in a first direction while the third bit does not rotate.

In yet another embodiment, a drum key for torquing a tension rod in a percussion instrument has a first torquing bit extending in an axial direction and a second torquing bit extending coaxial to the first torquing bit. Each of the first torquing bit and second torquing bit has a socket configured to engage with an end of a tension rod. The second torquing bit is rotationally locked with the first torquing bit. A one-way bearing assembly is operatively connected to the first bit and the second bit. A cord is wound about the one way bearing assembly with an end that is accessible by a user. Forcibly unwinding the cord to an extended position via human action causes the bearing, first torquing bit and second torquing bit to rotate in a first absolute direction. Releasing the cord from the extended position causes the bearing to rotate in a second absolute direction opposite from the first absolute direction and wind the cord.

### BRIEF DESCRIPTION OF THE DRAWINGS

FIG. 1 shows an embodiment of the disclosed torquing tool in the form of a drum key in perspective view;

FIG. 2 is a side elevation view of the tool of FIG. 1;

FIG. 3 is a front elevation view of the tool of FIG. 1;

FIG. 4 is an exploded view of the tool of FIG. 1;

FIG. 5 is a cross sectional view of the disclosed tool;

FIG. 6 shows the disclosed tool with a first rotatable bit engaged with a rotatable element;

FIG. 7 shows the disclosed tool with a stationary bit engaged with a rotatable element;

FIG. 8A shows an exemplary drum with tension rods that installable and removable with the disclosed tool;

FIG. 8B is an enlarged view of the portion of the drum of FIG. 8B showing a tension rod;

FIGS. 9A-9B show an alternative embodiment of the torquing tool with a torque limiting protection mechanism;

FIGS. 10A-10C show an alternative embodiment of the torquing tool with a different torque limiting protection mechanism; and

FIGS. 11A-11B show an alternative embodiment of the torquing tool with a different torque limiting protection mechanism.

### DETAILED DESCRIPTION

Among the benefits and improvements disclosed herein, other objects and advantages of the disclosed embodiments will become apparent from the following wherein like numerals represent like parts throughout the figures. Detailed embodiments of a torquing tool with pull cord, that may take the form of a drum key, are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

Unless the context dictates the contrary, all ranges set forth herein are inclusive of their endpoints and open-ended ranges include only commercially practical values. Similarly, all lists of values are inclusive of intermediate values unless the context indicates the contrary. The recitation of ranges of values herein is merely intended to serve as a shorthand method of referring individually to each separate value falling within the range. Thus, unless otherwise indicated herein, each individual value of a range is incorporated into the specification as if it were individually recited herein. The use of any and all examples, or exemplary language (e.g., “such as”) provided with respect to certain embodiments herein is intended merely to better illuminate the inventive subject matter and is not a limitation on the scope of the inventive subject matter otherwise described and claimed.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

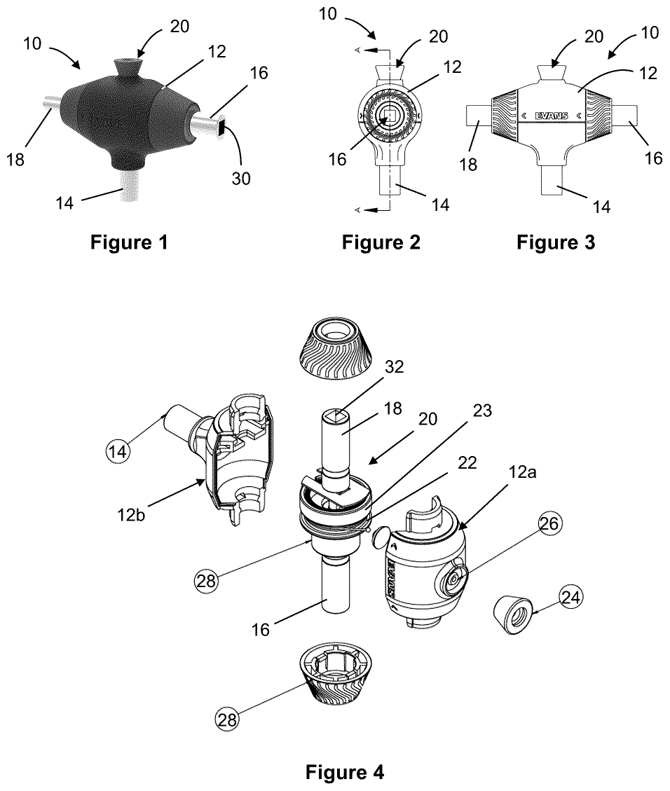

With reference to FIGS. 1-5, which show a non-limiting preferred embodiment of the torquing tool 10, the tool most generally includes opposing rotating driving bits, 16 and 18, and a stationary bit 14 approximately perpendicular to the rotating driving bits, 16a and 18, maintained in relative position via a central housing or frame 12. In the depicted embodiment, the tool 10 is in the form of a drum key and each of the bits, 14, 16 and 18, have a commonly shaped socket, 30, 32, 34, respectively, sized and shaped to engage with a rectangular prismic top end of a tension rod. The exact dimension and configuration of the sockets in the preferred embodiment are non-limiting, as the inventive concepts embodied within the torquing tool 10 are applicable to sockets of any shape and size. In other embodiments, one or more of the bits is removable and replaceable with a bit having a different socket.

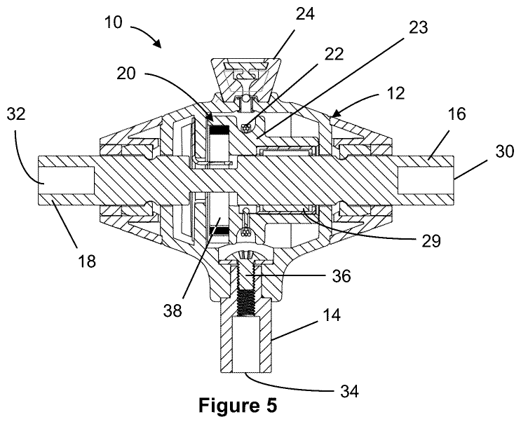

The rotating bits form part of a spinning key assembly with a one-way bearing unit 20. The bearing unit 20 is operatively engaged with each of the rotating bits, 16 and 18. As shown in the cross section of FIG. 5, the rotating bits, 16 and 18, may be formed as a single integral unit, however, this configuration is not required. The bearing unit 20 is configured to be freely rotatable relative to the rotating bits, 16 and 18, in a first direction and rotatably locked relative to the rotating bits in the opposite second direction. This arrangement will rotatably drive the bits, 16 and 18, when the bearing unit spins in the second direction and allow the bearing to spin freely in the first direction without causing rotation of the bits.

As will be explained in greater detail below, and as shown in FIG. 5, the bearing assembly includes an internal torsion spring 38 under tension that provides a rotational biasing force in the first direction wherein the bearing can spin freely. The rotating bits, 16 and 18, are rotationally independent from the housing 12, and the stationary bit 14 is rotationally fixed relative to the housing 12. In the depicted non-limiting embodiment, the stationary bit 14 is secured to the housing via a set screw 36. The housing 12 may also include end caps around one or more of the bits like those shown as reference numeral 28. The end caps 28 primarily provide improved aesthetics and contribute to the comfortable ergonomics for users. The housing 12 may also be formed from multiple sub-parts, 12a and 12b, joined together around the spinning key assembly 20.

As depicted in FIGS. 4 and 5, the bearing unit 20 is driven by a pull cord assembly, comprising a cord 22 wrapped around an outer spindle housing or shell 23 of the bearing assembly 20 and an external knob 24. The cord 22 extends through a hole 26 in the drum key housing 12 with the knob 24 attached to the end of the cord on the outside, exposed and accessible to a user.

In this particular embodiment, the bearing unit 20 utilizes a one-way needle bearing 29. However, other embodiments exist that utilize other comparable one-way rotation systems such as a clutch or one-way ratchet bearing in place of the needle bearing.

The rotating bits, 16 and 18, are rotationally locked to one another, and rotationally locked relative to the internal bearing unit spindle 23 in one direction by the needle bearing (second direction described above). This allows the spindle 23 to rotate freely relative to the bits, 16 and 18, in the opposite direction (first direction described above). As the cord 22 is pulled out from the housing 12 and unspooled from the bearing unit 20, the needle bearing 29 locks, thereby causing the bits, 16 and 18, to rotate in a common absolute direction with the bearing assembly housing driven by the cord unspooling. When a user releases the extended cord 22, the cord retracts into the housing under the force of the spring 38 while the needle of the bearing is allowed to spin freely so that the bits, 16 and 18, do not rotate in the reverse direction with the bearing unit 20. This re-spools the cord about the spindle 23.

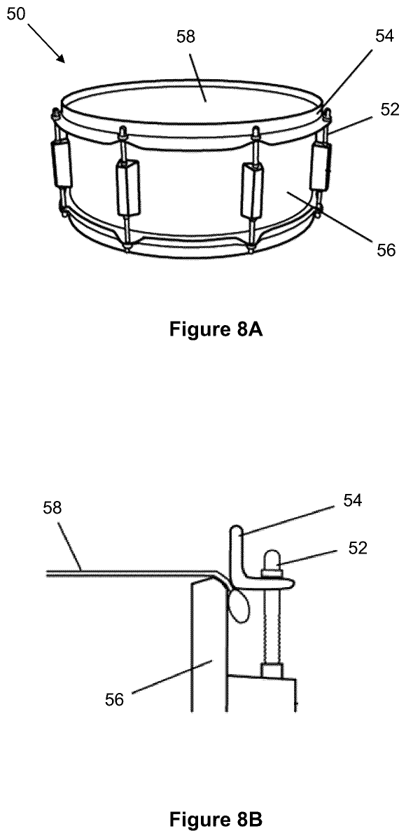

FIG. 8A depicts an exemplary drum 50 with tension rods 52 for adjusting tension in a membrane 58 stretched across a hoop 54 mounted on a substantially cylindrical frame 56. FIG. 8B shows an enlarged view of the portion of the drum showing a tension rod 52 engaged with the hoop 54 that maintains the membrane. As those familiar with the musical instrument and percussion industry understand, tension rods 52 are torqued to adjust tension across the membrane 52, wherein tightening the tension rod 52 increases tension in the membrane and loosening the tension rod 52 decreases tension in the membrane.

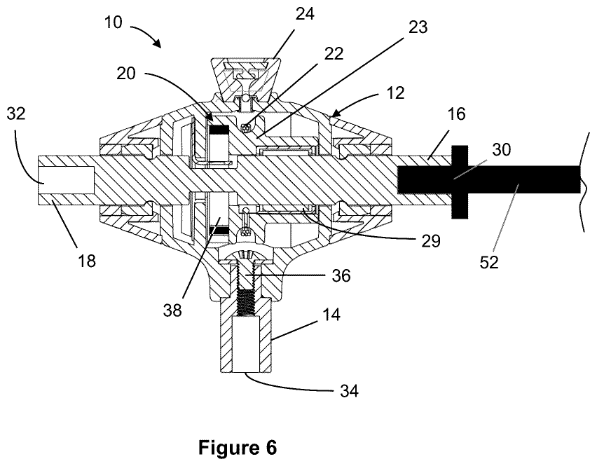

Within the context of a drum key, the cord-driven bits, 16 and 18, greatly improve tension rod 50 installation and uninstallation efficiency similar to a power tool, but without the same level of power that risks damage to the drum hardware. Engagement of the first rotating bit 16 with a tension rod 50 is depicted in FIG. 6 (note other drum hardware omitted for clarity).

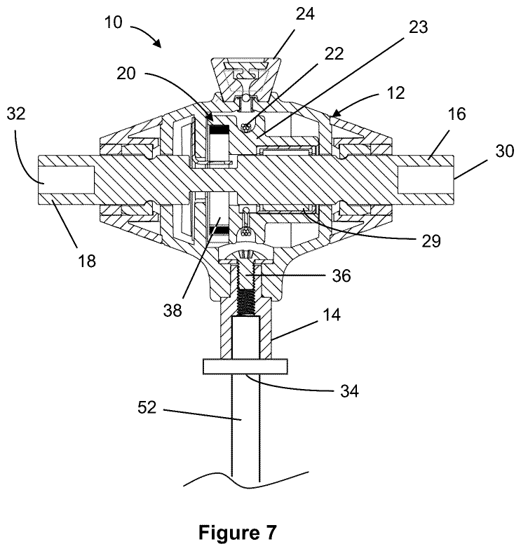

Additionally, as depicted in FIG. 7, a user can engage the stationary bit 14 with a tension rod 50 in situations that warrant finer torquing sensitivity and rotate the tension rod 50 as is customary with stationary drum keys. When the stationary bit 14 is engaged, portions of the perpendicular end caps 28 and/or rotating bits, 16 and 18, are used by a user as the leveraging cross member to provide torquing force. The stationary bit 14 is typically engaged after tension rods 50 are installed with the rotating bit 16 to fine tune the acoustics of a drum, and can also be used to initially loosen or begin uninstallation of a tension rod that may be stuck.

To install a tension rod 50, a user can engage a first of the bits 16 with a tension rod and then grip the knob and pull the cord. Pulling the cord rotates the driving bit 16 and drives the tension rod in the installation direction (usually clockwise). Once the user releases the cord, the cord retracts into the housing 12 without causing the bit 16 to rotate, and thus the tension rod is not turned back in the opposite direction. This process can be repeated as many times as needed. A user can thereafter optionally use the stationary bit 14 to finely torque the tension rod.

To uninstall a tension rod, the user simply engages the opposite rotating bit 18 and pulls the cord 22, causing the tension rod to rotate in the opposite direction (usually counterclockwise). Note that the first rotating bit 16 and second rotating bit 18 are rotationally locked relative to each other so that they rotate in the same absolute direction with the bearing unit 20 when the cord is pulled. This effects rotation in opposite installation directions when the second rotating bit 18 is engaged with the element as opposed to the first rotating bit 16 being engaged with the element.

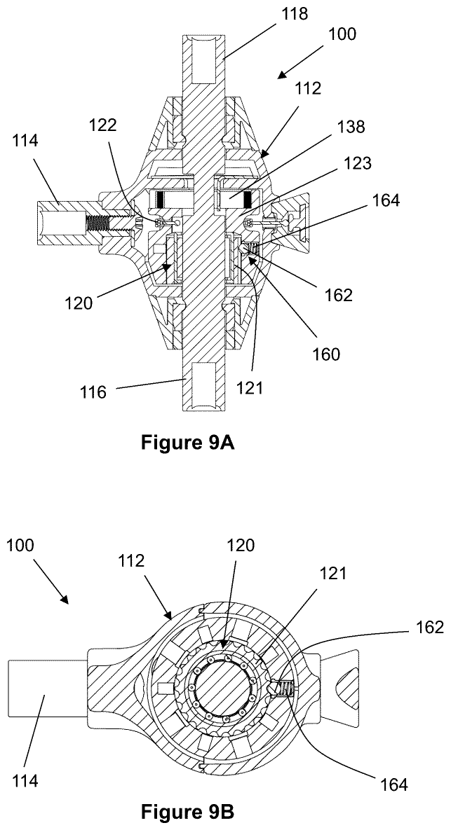

FIGS. 9A and 9B depict an embodiment of the torquing tool 100 that includes a torque limiting protection mechanism 160 to prevent inadvertent breakage of the cord 122 under an excessive pulling force. In this embodiment, the protection mechanism 160 comprises one or more balls 162 with an associated spring 164 biasing the ball 162 radially inward received within the outer spindle or shell 123. In this embodiment, the bearing unit 120 includes an outer casing 121 with a series of circumferentially spaced apart ribs 125 is molded with a plurality of spaced apart ribs (or nubs) 125 facing the outer spindle 123. Each set of adjacent ribs 125 is spaced apart by a groove 127 sized and shaped to receive a portion of the outer surface of the inwardly biased ball 162. In one embodiment, the ribs 125 and grooves 127 are configured to be vertically extending over a portion of the outer casing 121 of the bearing unit 120, however, this is non-limiting.

The protection mechanism 160 is configured with spring force, sizes and surface contours specifically tuned so that the ball 162 mates within a groove and maintains a quasi-locked engagement such that tensioning the cord 122 by pulling with a torquing force within a predetermined “safe” range rotates the rotating bits, 116 and 118, as in the earlier embodiment. However, if the tension applied on the cord 122 exceeds a predetermined threshold, the bearing unit 120 will slip by the ball 162 depressing radially outward against the force of the spring 164 under pressure from the ribs 125. This prevents the cord 122 from breaking under an excessive tensioning force, typically caused by a user using the cord 122 to torquingly drive hardware that is stuck or already fully installed.

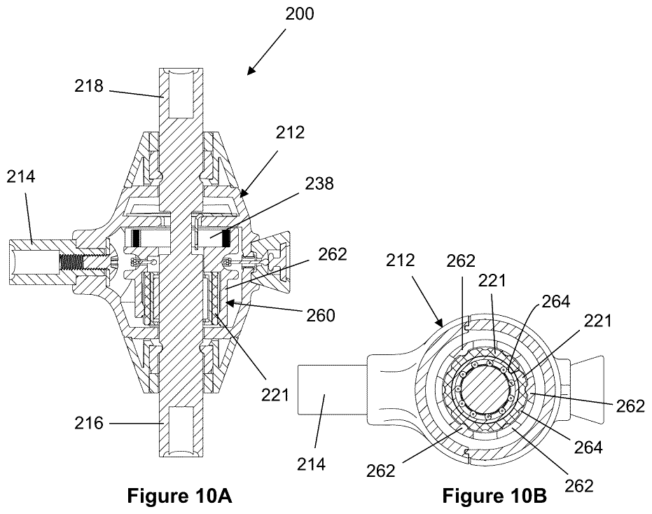

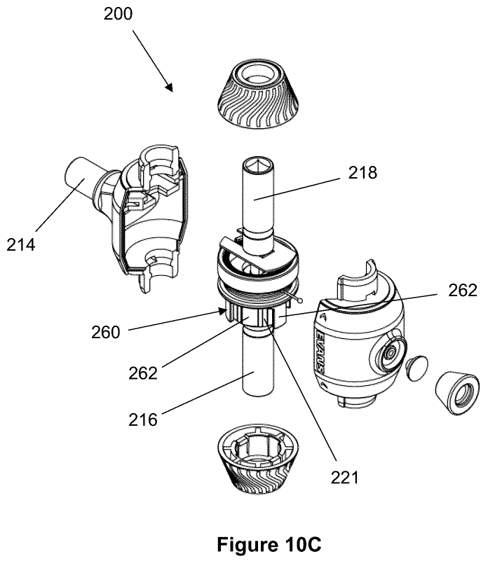

FIGS. 10A-10C depict another embodiment of the torquing tool 200 with a different torque limiting protection mechanism 260. The protection mechanism 260 of this embodiment, operates according to similar mechanical principles as the mechanism 160 of the tool 100 described in the preceding paragraphs. In this embodiment, the protection mechanism 260 comprises a plurality of fingers 262 molded into the outer spindle 123, each having a nub or projection 264 that extends radially inward. The bearing unit 220 is formed with an outer casing 221 that is similar in form to the outer casing 121 of the earlier embodiment, having circumferentially spaced apart ribs and grooves. The protection mechanism 260 is configured such that the nub 264 of each finger 262 is received within a groove between ribs of the outer casing 221. When the cord 222 is tensioned by pulling with a force within a predetermined “safe” range, the nubs 264 remain within the grooves in a quasi-locked engagement, allowing the bearing to rotate the rotating bits, 116 and 118. When the torquing force exceeds a predetermined threshold, the bearing unit 220 slips via the fingers 262 flexing radially outwardly to disengage the nubs 264 from the grooves of the outer casing 221, allowing the bearing to slip and the cord to extend, preventing it from breaking under undue tension.

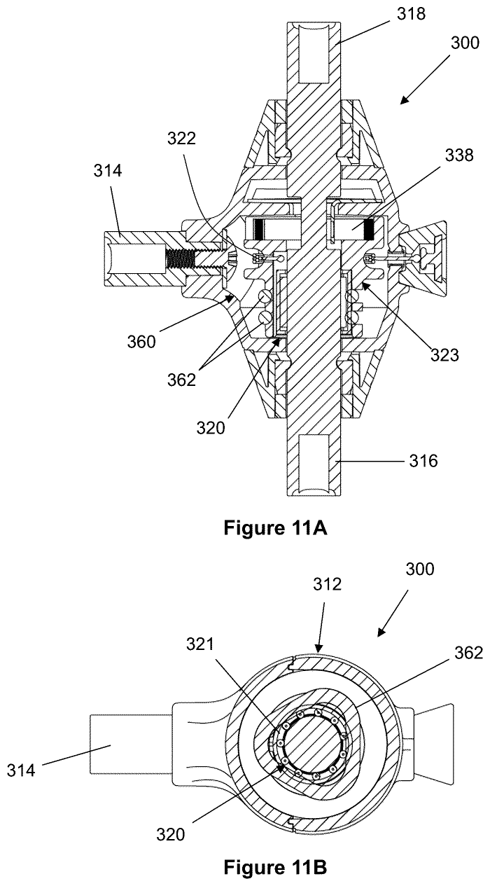

FIGS. 11A-11B show yet another embodiment of the torquing tool 300 with a different torque limiting protection device 360. In this embodiment, the outer spindle 323 is molded with one or more inwardly opening grooves 364 that receives a resilient O-ring 262. In the depicted embodiment, at least a portion of the groove 264 is open to an area interior of the spindle 323 such that the O-ring contacts the outer surface of the outer casing 321 of the bearing unit 320. This embodiment includes two O-rings, however this is non-limiting. Additionally, with reference to FIG. 10B, each groove 364 in the spindle 323 is open at three locations, generally graphically represented by the straighter segments of the quasi-triangular looking O-ring 362. In this embodiment, the O-rings frictionally engage the outer surface of the bearing outer casing 321 such that when the cord 322 is pulled with a force within the predetermined “safe” range, it causes the bearing and associated bits, 316 and 318, to rotate. However, when a predetermined torquing force is exceeded, the force overcomes the frictional force between the O-rings 362 and outer casing 321, allowing the bearing to slip and the cord to extend, preventing it from breaking under undue pulling force.

In FIGS. 9A-9B, 10A-10C and 11A-11B, elements common to the first embodiment of the torquing tool 10 are identified with reference numerals having the same trailing two digits following “1”, “2”, or “3” for reference and context. For example, key elements of the torquing tool 100 in FIGS. 9A-9B include: tool housing 112, stationary bit 114, first rotating bit 116, second rotating bit 118, bearing unit 120 and internal torsion spring 138; key elements of the torquing tool 200 in FIGS. 10A-10C include: tool housing 212, stationary bit 214, first rotating bit 216, second rotating bit 218, bearing unit 220 and internal torsion spring 238; and key elements of the torquing tool 300 in FIGS. 11A-11B include: tool housing 312, stationary bit 314, first rotating bit 316, second rotating bit 318, bearing unit 320 and internal torsion spring 338.

The specific depicted and disclosed embodiment of the tool 10/100/200/300 is a unique drum key with bits, 14/114/214/314, 16/116/216/316, 18/118/218/318, that have engagement profiles (i.e., sockets, 30/130/230/330, 32/132/232/332 and 34/134/234/334) sized and shaped to engage with a tension rod 52 of a drum 50. However, those skilled in the art will readily understand that the torquing tool 10 is in no way limited to this specific preferred embodiment and/or bits with these engagement profiles. Additional embodiments of the torquing tool exist that embody the inventive features of a pull cord-powered driver bit or bits with one-way bearing which may be reversible and/or may include a separate stationary bit. For example, numerous other non-depicted tools have bits with respective engagement profiles for torquing other rotatable elements. Further, embodiments exist with removable and replaceable driver bits for engaging a variety of different rotationally drivable elements, such as screws, bolts, nuts and similar.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A tool for use in torquing a drivable element, comprising:
a first bit configured to engage with the drivable element;
a one-way bearing assembly operatively connected to the first bit; and
a cord wound about the one way bearing assembly, wherein
forcibly unwinding the cord causes the bearing and first bit to rotate in a first direction.

2. The tool of claim 1, comprising a second bit opposite the first bit and operatively connected to the bearing assembly, wherein forcibly unwinding the cord causes the bearing a second bit to rotate in the first direction.

3. The tool of claim 2, wherein engaging the first bit with a drivable element and forcibly unwinding the cord causes the first bit to drive the drivable element in a first installation direction.

4. The tool of claim 3, wherein engaging the second bit with a drivable element and forcibly unwinding the cord causes the second bit to drive the drivable element in an opposite second uninstallation direction.

5. The tool of claim 1, comprising a third bit configured to engage with a drivable element, wherein the third bit is rigid relative to the first bit and not operatively engaged with the bearing assembly.

6. The tool of claim 5, wherein the stationary bit extends substantially perpendicular to the first bit.

7. The tool of claim 2, comprising a third bit configured to engage with a drivable element, wherein the third bit is rigid relative to the first bit and second bit and not operatively engaged with the bearing assembly.

8. The tool of claim 7, wherein the stationary bit extends substantially perpendicularly to the first bit and second bit.

9. The tool of claim 8, wherein the tool is a drum key and each of the bits includes a socket sized and shaped to engage a tension rod of a drum.

10. The tool of claim 1, wherein the tool is a drum key and the first bit includes a socket sized and shaped to engage a tension rod of a drum.

11. The tool of claim 1, wherein the one-way bearing assembly is selected from the group consisting of a needle bearing, ratchet bearing and other geared ratchet mechanism.

12. The tool of claim 1, wherein the one-way bearing assembly is a needle bearing.

13. The tool of claim 1, wherein the first bit includes a socket defining a shape that is substantially rectangular prismic.

14. The tool of claim 7, wherein at least one of the first bit, second bit and third bit is removable and replaceable with an alternate bit having a different socket profile.

15. The tool of claim 1, comprising a torque limiting protection unit configured to maintain engagement with the bearing unit to rotate the bearing unit and first bit when the cord is forcibly unwound with a torquing force below a predetermined threshold, and disengage from the bearing unit when the cord is forcibly unwound with a torquing force above the predetermined threshold.

16. A tool for use in torquing a drivable element, comprising:
a frame;
a first bit with an engagement profile configured to engage with a drivable element and being rotatable relative to the frame;
a second bit extending opposite from the first bit and having an engagement profile configured to engage with a drivable element, the second bit being rotationally fixed relative to the first bit and rotatable relative to the frame;
a third bit that is rotationally fixed relative to the frame and has an engagement profile configured to engage with a drivable element;
a one-way bearing assembly operatively connected to the first bit and second bit; and
a cord wound about the one way bearing assembly with an end exposed from the frame, wherein
forcibly unwinding the cord by human action causes the bearing, first bit and second bit to rotate in a first direction while the third bit does not rotate.

17. The tool of claim 16, wherein each of the first bit, second bit and third bit has a socket substantially the same shape and size as one another.

18. The tool of claim 16, wherein the third bit extends in a direction substantially perpendicular to the first bit and second bit.

19. The tool of claim 16, wherein at least one of the first bit, second bit and third bit is removable and replaceable with an alternate bit having a different engagement profile.

20. A drum key for torquing a tension rod in a percussion instrument, comprising:
a first torquing bit with a socket configured to engage with an end of a tension rod extending in a first axial direction;
a second torquing bit with a socket configured to engage with an end of a tension rod coaxial and extending coaxial to the first torquing bit, the second torquing bit being rotationally locked with the first torquing bit;
a one-way bearing assembly operatively connected to the first bit and the second bit; and
a cord wound about the one way bearing assembly with an end accessible by a user, wherein
forcibly unwinding the cord to an extended position via human action causes the bearing, first torquing bit and second torquing bit to rotate in a first absolute direction, and
releasing the cord from the extended position causes the bearing to rotate in a second absolute direction opposite from the first absolute direction and wind the cord without rotating the first torquing bit or second torquing bit.

21. The drum key of claim 19, further comprising a third torquing bit extending perpendicular to the first torquing bit and second torquing bit, wherein the third torquing bit is rotationally independent from the first torquing bit and second torquing bit.
